(19) United States
(12) Patent Application Publication
(10) Pub. No.: US 2014/0233746 A1
(43) Pub. Date: Aug. 21, 2014

(54) EARPHONE MICROPHONE

(71) Applicant: FUNAI ELECTRIC CO., LTD., Osaka (JP)

(72) Inventors: Fuminori TANAKA, Osaka (JP); Noriyuki SHIMIZU, Osaka (JP)

(73) Assignee: FUNAI ELECTRIC CO., LTD., Osaka (JP)

(21) Appl. No.: 14/174,983

(22) Filed: Feb. 7, 2014

(30) Foreign Application Priority Data
Feb. 20, 2013 (JP) 2013-030793

(51) Int. Cl. H04R 1/10

(52) U.S. Cl. CPC H04R 1/1083; H04R 1/1058
USPC 381/66

(57) ABSTRACT

An acoustic space including a sound output path, first and second sound input paths is formed in a main body casing of an earphone microphone. Output sound from a speaker propagates in the sound output path. Sound input to a first microphone propagates in the first sound input path communicating with outside. Sound input to a second microphone propagates in the second sound input path. The sound output path branches into one path communicating with the outside of the main body casing and the other path communicating with the second sound input path. The earphone microphone amplifies a sound signal output from at least one of the first and second microphones so as to input sound from a sound source outside the main body casing, and suppresses input of the output sound.

This application is based on Japanese Patent Application No 2013-030793 filed on Feb. 20, 2013, contents of which are hereby incorporated by reference.

### BACKGROUND OF THE INVENTION

1. Field of the Invention

The present invention relates to an earphone microphone, and particularly to an earphone microphone including a speaker and a microphone.

2. Description of Related Art

Conventionally, there is known an earphone microphone including a speaker and a microphone. Using the earphone microphone set in the ear, a user can hear sounds such as voice output from the speaker while transmitting sounds such as user's voice input to the microphone. Therefore, the earphone microphone is used for handsfree communication using a cellular phone or the like.

However, the sound output from the speaker to the user's external auditory meatus is echoed by the user's tympanum, the external auditory meatus, and the like to enter the earphone microphone as noise (echo component). Therefore, the microphone in the earphone microphone collects not only the user's voice but also the echo component of the sound output from the speaker. Consequently, there is a problem that the echo component is mixed as noise into the voice sound transmitted from the earphone microphone.

Therefore, there is known an earphone microphone having an echo cancel function as described in JP-A-2007-201887, for example. The earphone microphone described in JP-A-2007-201887 includes two speakers and a microphone. One of the speakers outputs sound such as speaking voice. The other speaker outputs sound for canceling the echo component of the sound output from the one of the speakers. The echo component of the sound output from the one of the speakers and the sound output from the other speaker are input to the microphone. Then, they are canceled by each other so that the echo component is suppressed.

However, the earphone microphone described in JP-A-2007-201887 includes a plurality of speakers in a main body casing. For this reason, a space for housing the speakers and their sound paths increases in the main body casing. Therefore, there is a problem that it is difficult to downsize the main body casing. In addition, there is another problem that it becomes relatively expensive because of manufacturing cost.

### SUMMARY OF THE INVENTION

The present invention is made in view of the abovementioned problem, and it is an object thereof to provide an earphone microphone having an echo suppression function that is inexpensive and can be downsized.

In order to achieve the above-mentioned object, an earphone microphone according to a first aspect of the present invention includes a single speaker, first and second microphones, a main body casing, and an output controller. An acoustic space is formed in the main body casing. The output controller amplifies a sound signal output from at least one of the first and second microphones. The acoustic space includes a sound output path, a first sound input path, and a second sound input path. Output sound from the speaker propagates in the sound output path. The first sound input path communicates with outside of the main body casing. Sound to be input to the first microphone propagates in the first sound input path. Sound to be input to the second microphone propagates in the second sound input path. The sound output path branches into one path communicating with outside of the main body casing and the other path communicating with the second sound input path. The earphone microphone inputs sound from a sound source outside the main body casing by amplifying the sound signal and suppresses input of the output sound from the speaker.

With this structure, the earphone microphone includes the single speaker. In addition, the sound output path branches into the one path communicating with outside of the main body casing and the other path communicating with the second sound input path. For this reason, the output sound from the speaker propagates to the first microphone via the one path and the first sound input path, and also propagates to the second microphone via the other path and the second sound input path. Further, the earphone microphone inputs sound from the outside sound source by amplifying the sound signal output from at least one of the first and second microphones, and suppresses input of the output sound from the speaker. For this reason, the earphone microphone can realize the echo suppression function of the output sound from the speaker without using a plurality of speakers. Further, the earphone microphone can transmit input sound while suppressing noise due to the output sound from the speaker. Therefore, it is possible to provide an earphone microphone having the echo suppression function that is inexpensive and can be downsized.

Further features and advantages of the present invention will become apparent from the description of embodiments given below.

### BRIEF DESCRIPTION OF THE DRAWINGS

FIG. 1 is an outside perspective view of an earphone microphone.

FIG. 2 is a diagram illustrating the earphone microphone inserted into a user's external auditory meatus.

FIG. 3 is a cross-sectional view of a main body according to a first embodiment.

FIG. 4 is a front view of the main body viewed from the user's external auditory meatus in the first embodiment.

FIG. 5 is a side view of the main body.

FIG. 6A is a front view illustrating another example of forming second and third apertures in the first embodiment.

FIG. 6B is a front view illustrating still another example of forming the second and third apertures in the first embodiment.

FIG. 6C is a front view illustrating still another example of forming the second and third apertures in the first embodiment.

FIG. 7 is a block diagram illustrating a structure of a control unit.

FIG. 8 is a conceptual structural diagram illustrating propagation paths of output sound from a speaker to be input to first and second microphones in the first embodiment.

FIG. 9 is a sound input block diagram of the output sound in the first embodiment.

FIG. 10 is a conceptual structural diagram illustrating propagation paths of input sound from an outside sound source to the first and second microphones in the first embodiment.

FIG. 11 is a sound input block diagram of input sound in the first embodiment.

FIG. 12 is a conceptual structural diagram of an earphone microphone according to a second embodiment.

FIG. 13 is a front view of a main body viewed from the user's external auditory meatus in the second embodiment.

FIG. 14A is a front view illustrating another example of forming second to fourth apertures in the second embodiment.

FIG. 14B is a front view illustrating still another example of forming the second to fourth apertures in the second embodiment.

FIG. 15 is a conceptual structural diagram illustrating propagation paths of output sound from the speaker to be input to the first and second microphones in the second embodiment.

FIG. 16 is a sound input block diagram of the output sound in the second embodiment.

FIG. 17 is a conceptual structural diagram illustrating propagation paths of input sound from an outside sound source to the first and second microphones in the second embodiment.

FIG. 18 is a sound input block diagram of input sound in the second embodiment.

FIG. 19 is a conceptual structural diagram illustrating another example of the earphone microphone according to the first embodiment.

FIG. 20 is a conceptual structural diagram illustrating still another example of the earphone microphone according to the first embodiment.

### DETAILED DESCRIPTION OF THE PREFERRED EMBODIMENTS

Now, with reference to the drawings, embodiments of the present invention are described.

### First Embodiment

(Structure of Earphone Microphone)

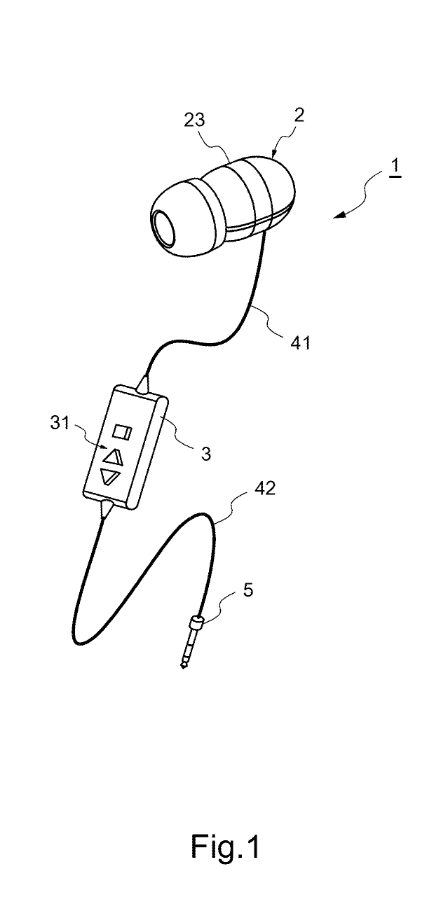

FIG. 1 is an outside perspective view of an earphone microphone. An earphone microphone 1 is a sound input and output device connected to electronic equipment (not shown) such as a cellular phone, for example. As illustrated in FIG. 1, the earphone microphone 1 includes a main body 2, a control unit 3, a first cable 41, a second cable 42, and a connector 5.

The main body 2 is inserted into a user's ear, so as to output sound and to input sound from an outside sound source (for example, user's speaking voice). Note that specific structures of the main body 2 and the control unit 3 are described later. The first cable 41 is a signal line that is connected between the main body 2 and the control unit 3 so as to transmit and receive signals between the main body 2 and the control unit 3. The second cable 42 is a signal line that is connected between the control unit 3 and the connector 5 so as to transmit and receive signals via the connector 5 between the control unit 3 and electronic equipment (not shown) connected to the earphone microphone 1. The connector 5 is an input and output terminal connected to an interface of the electronic equipment (not shown).

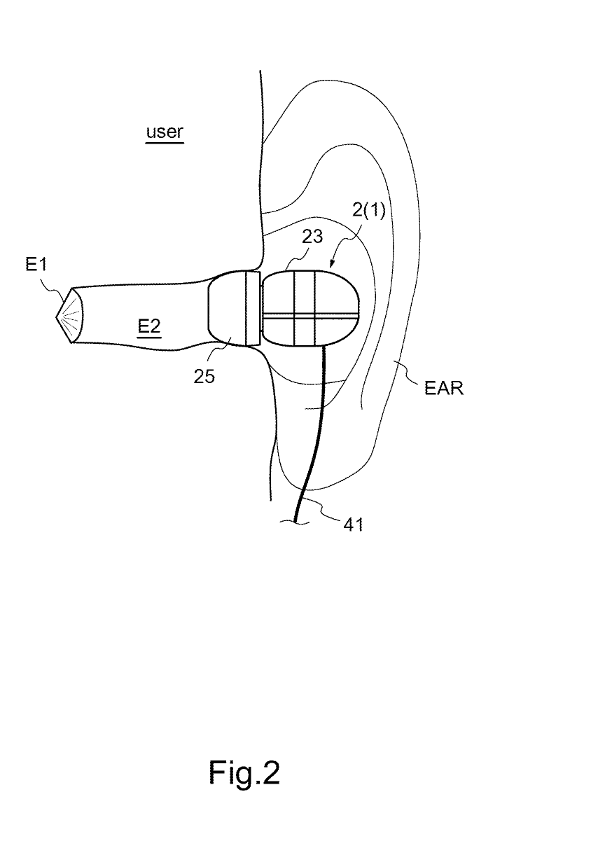

FIG. 2 is a diagram illustrating a state where the earphone microphone is inserted into a user's external auditory meatus. As illustrated in FIG. 2, the earphone microphone 1 is inserted in a user's ear EAR and outputs sound based on a sound signal output from the electronic equipment (not shown) to a user's tympanum E1. In addition, the voice generated by the user is not only output from the mouth, but also a part of the voice is transmitted through the skull or the face muscle and is output to an external auditory meatus E2 from the tympanum E1. The earphone microphone 1 inputs the sound such as user's speaking voice (namely input sound from the outside sound source) and further generates a sound signal based on the input sound so as to output the sound signal to the electronic equipment (not shown). Note that the electronic equipment connected to the earphone microphone 1 is not limited to a specific one.

Here, the output sound output from the earphone microphone 1 to the user's external auditory meatus E2 is echoed by the user's tympanum E1, the inner wall of the external auditory meatus E2, and the like so as to enter the earphone microphone 1 as noise. In the following description, this noise is referred to as an echo component. The earphone microphone 1 has an echo suppression function for suppressing noise due to the echo component, as described later. For this reason, the earphone microphone 1 can input clear voice in which the noise (in particular, the echo component of the output sound) is suppressed.

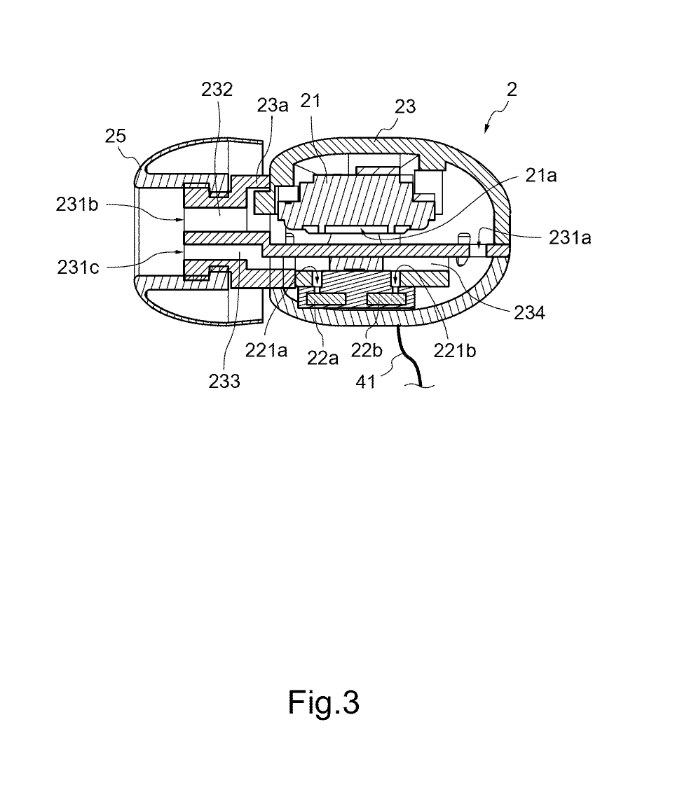

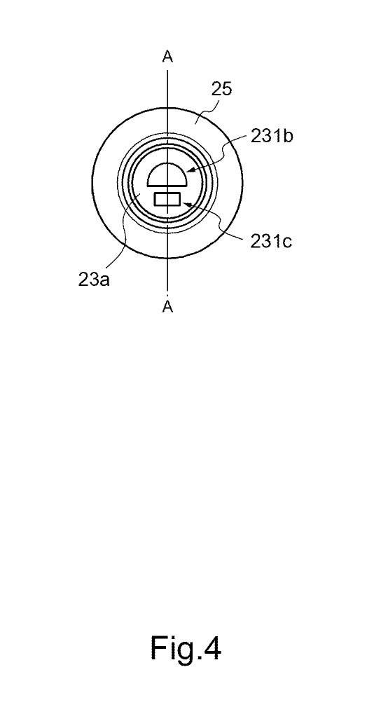

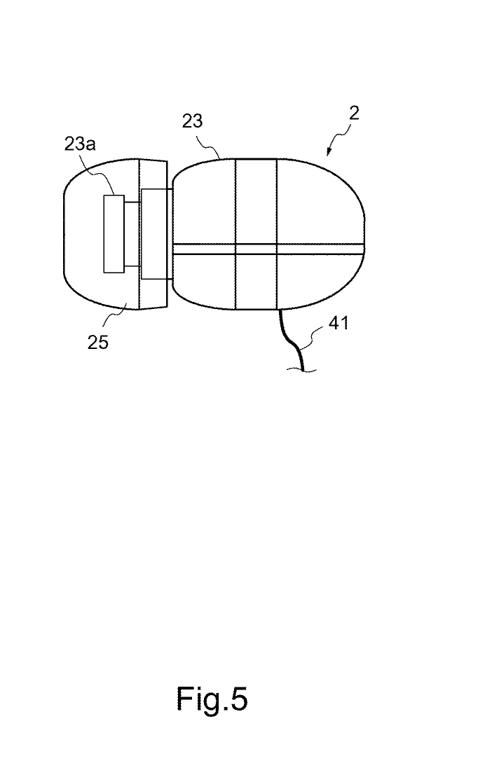

Next, a structure of the main body 2 is described in detail. FIG. 3 is a cross-sectional view of a main body in the first embodiment. In addition, FIG. 4 is a front view of the main body viewed from the user's external auditory meatus in the first embodiment. In addition, FIG. 5 is a side view of the main body. Note that FIG. 3 illustrates a cross-sectional structure of the main body 2 taken along a dashed dotted line A-A in FIG. 4.

As illustrated in FIG. 3, the main body 2 includes a speaker 21, a first microphone 22a, a second microphone 22b, a main body casing 23, and an ear pad 25.

The speaker 21 is a voice output unit having a sound output hole 21a through which the output sound is output. The speaker 21 is electrically connected to the first cable 41 so as to output the output sound based on a sound signal transmitted from the electronic equipment (not shown) via the connector 5. Note that in FIG. 3, the sound output hole 21a of the speaker 21 faces a direction substantially perpendicular to the extending direction of a sound output path 232, but the direction of the speaker 21 is not limited to the direction exemplified in FIG. 3. The direction of the speaker 21 may be substantially parallel to the extending direction of the sound output path 232 described later, for example.

The first and second microphones 22a and 22b are voice input units, and are electrically connected to the control unit 3 (in particular, a control device 32 described later) via the first cable 41. The first and second microphones 22a and 22b are not limited to specific ones but may be MEMS microphones or ECM microphones, for example. The first microphone 22a has a first sound input hole 221a and generates a first sound signal on the basis of voice input to the first sound input hole 221a. In addition, the second microphone 22b has a second sound input hole 221b and generates a second sound signal on the basis of voice input to the second sound input hole 221b. The generated first and second sound signals are output to the control unit 3 via the first cable 41. Note that in FIG. 3, the first and second sound input holes 221a and 221b are arranged in a direction substantially parallel to the extending direction of the sound paths (such as the sound output path 232) described later, but the arrangement direction of them is not limited to the one exemplified in FIG. 3.

In the main body casing 23, the single speaker 21 and the first and second microphones 22a and 22b are mounted. In addition, as illustrated in FIGS. 3 to 5, an insertion part 23a is formed in the main body casing 23. As illustrated in FIG. 4, second and third apertures 231b and 231c for inputting and outputting voice to the earphone microphone 1 are formed in the insertion part 23a on a surface opposed to the user's tympanum E1 when the main body 2 is set to the user's ear EAR as illustrated in FIG. 2.

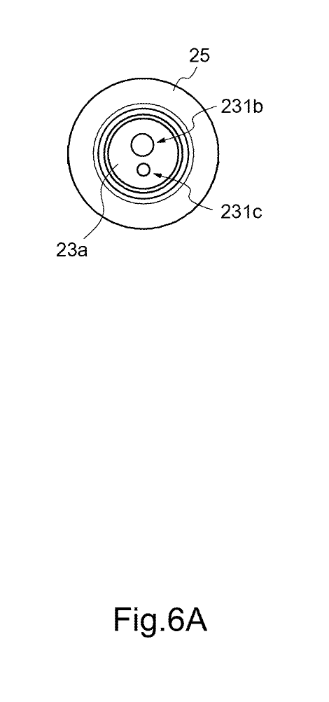

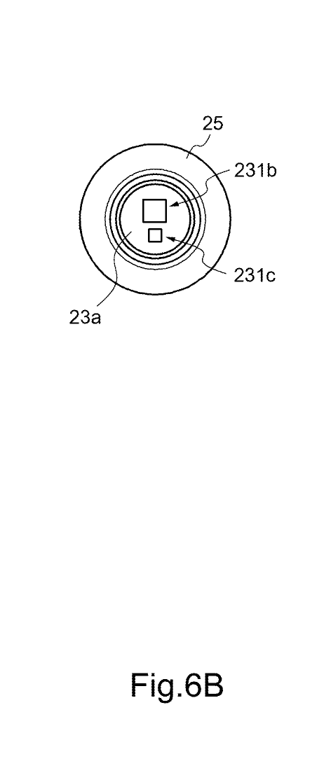

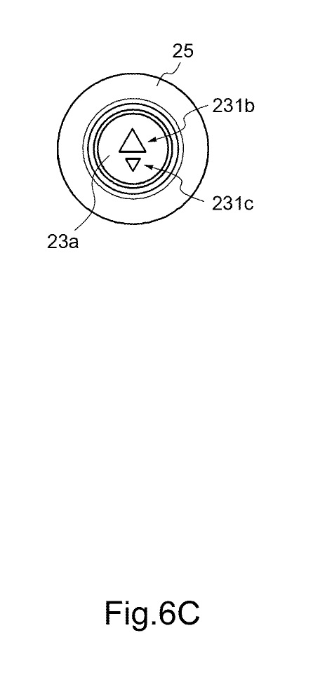

Note that shapes of the second and third apertures 231b and 231c formed in the insertion part 23a are not limited particularly. FIGS. 6A to 6C are front views illustrating other examples of forming the second and third apertures in the first embodiment. The shapes of the second and third apertures 231b and 231c may be a circular shape (FIG. 6A) or a polygonal shape such as a square (FIG. 6B) or a triangle (FIG. 6C), for example. In addition, shapes as well as sizes of the second and third apertures 231b and 231c may be substantially the same or may be different.

In addition, as illustrated in FIG. 3, an acoustic space including the sound output path 232, a first sound input path 233, and a second sound input path 234 is formed in the main body casing 23.

The sound output path 232 is a sound path in which the output sound from the speaker 21 propagates. In this sound output path 232, the speaker 21 is disposed, and a first aperture 231a is formed so as to communicate with the second sound input path 234. For this reason, the sound output path 232 from the speaker 21 branches into one path communicating with outside of the main body casing 23 and the other path communicating with the second sound input path 234 via the first aperture 231a. The one path communicates with the second aperture 231b so as to permit the output sound from the sound output hole 21a of the speaker 21 to be output to the outside of the main body casing 23 via the second aperture 231b. The other path permits the output sound to propagate to the second sound input path 234 via the first aperture 231a. Note that a branch sound path for communicating the sound output path 232 with the second sound input path 234 may be formed instead of the first aperture 231a illustrated in FIG. 3 between the sound output path 232 and the second sound input path 234.

The first sound input path 233 is a sound path in which sound input to the first sound input hole 221a propagates and communicates with the third aperture 231c. Sound from outside of the main body casing 23 propagates to the first sound input path 233 via the third aperture 231c. For instance, an echo component of the output sound from the speaker 21 and input sound from the outside sound source (for example, user's speaking voice propagating via the tympanum E1 and the external auditory meatus E2) propagates. The first sound input path 233 conducts the sounds to the first sound input hole 221a.

In addition, the second sound input path 234 is a sound path in which sound input to the second sound input hole 221b propagates. Sounds such as the echo component of the output sound from the speaker 21 and the input sound from the outside sound source propagate from outside of the main body casing 23 to the second sound input path 234 via the second aperture 231b, the sound output path 232, and the first aperture 231a. Further, the output sound from the speaker 21 propagates directly to the second sound input path 234 via the sound output path 232 and the first aperture 231a. The second sound input path 234 conducts these sounds to the second sound input hole 221b.

The ear pad 25 is made of a resin material, a rubber material, or the like, for example, and is configured to cover the insertion part 23a. When the main body 2 is set to the user's ear EAR (see FIG. 2), the ear pad 25 is inserted together with the insertion part 23a into the user's external auditory meatus E2. In this case, the ear pad 25 seals a space between the insertion part 23a and the user's external auditory meatus E2 without a substantial gap. For this reason, external sound entering through the space between the insertion part 23a and the external auditory meatus E2 can be substantially blocked.

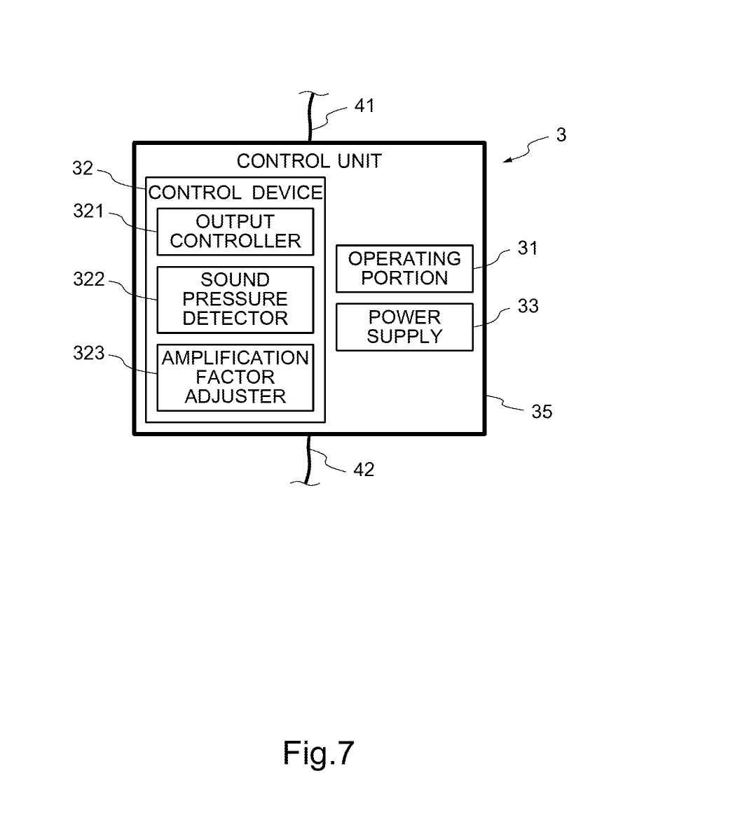

Next, a structure of the control unit 3 is described. FIG. 7 is a block diagram illustrating a structure of the control unit 3. As illustrated in FIG. 7, the control unit 3 includes an operating portion 31, a control device 32, a power supply 33, and a casing 35.

The operating portion 31 receives user's input operation such as for adjusting volume of the speaker 21.

The control device 32 controls individual components of the earphone microphone 1. As illustrated in FIG. 7, the control device 32 includes an output controller 321, a sound pressure detector 322, and an amplification factor adjuster 323.

The output controller 321 amplifies the first and second sound signals transmitted from the first and second microphones 22a and 22b by a gain K1 (first amplification factor) and a gain K2 (second amplification factor), respectively. In addition, the output controller 321 generates a difference sound signal between the amplified first and second sound signals. This difference sound signal is transmitted to the electronic equipment (not shown) connected to the earphone microphone 1 via the second cable 42 and the connector 5.

The sound pressure detector 322 detects sound pressure levels of the first and second sound signals sent from the first and second microphones 22a and 22b to the control device 32. Note that the timing at which the sound pressure detector 322 detects the sound pressure levels is not limited to specific timing. The detection timing may be in real time or at every predetermined time.

The amplification factor adjuster 323 automatically sets gains K1 and K2 used in the output controller 321 on the basis of a result of detection by the sound pressure detector 322. A method of setting the gains K1 and K2 is described later. Note that the amplification factor adjuster 323 may set the gains K1 and K2 on the basis of user input with the operating portion 31. In addition, the timing at which the amplification factor adjuster 323 automatically sets the gains K1 and K2 is not limited to specific timing. The gains K1 and K2 are automatically set so as to satisfy the expression 1 (or the expression 3) described later in a state where the output sound from the speaker 21 and the echo component thereof are predominantly input to the first and second microphones 22a and 22b. In addition, the gains K1 and K2 are automatically set so as to satisfy the expression 2 (or the expression 4) described later in a state where the input sound from the outside sound source (such as user's speaking voice) is predominantly input to the first and second microphones 22a and 22b. Further, it is possible to configure that each of the gains K1 and K2 can be adjusted by user's operation input from the operating portion 31.

The power supply 33 is a small-sized battery for supplying drive power to the control device 32 and other components. The power supply 33 may be a button type battery, a lithium-ion battery, or a lithium polymer battery, for example, but is not limited to a specific one.

The casing 35 is a housing in which the operating portion 31, the control device 32, the power supply 33, and the like are mounted. In addition, the operating portion 31 is disposed on an outside of the casing 35 (see FIG. 1). In addition, on the side opposite to the operating portion 31, there is disposed a clip (not shown) for clipping the casing 35 to clothing of the user (for example, to a collar or a pocket).

(Echo Suppression Function of Earphone Microphone)

Next, the echo suppression function of the earphone microphone 1 according to the first embodiment is described in a case where the output sound from the speaker 21 is input to the first and second microphones 22a and 22b, and in a case where the input sound from the outside sound source (such as user's speaking voice) is input to the first and second microphones 22a and 22b.

((In Case Where Output Sound from Speaker is Input to First and Second Microphones))

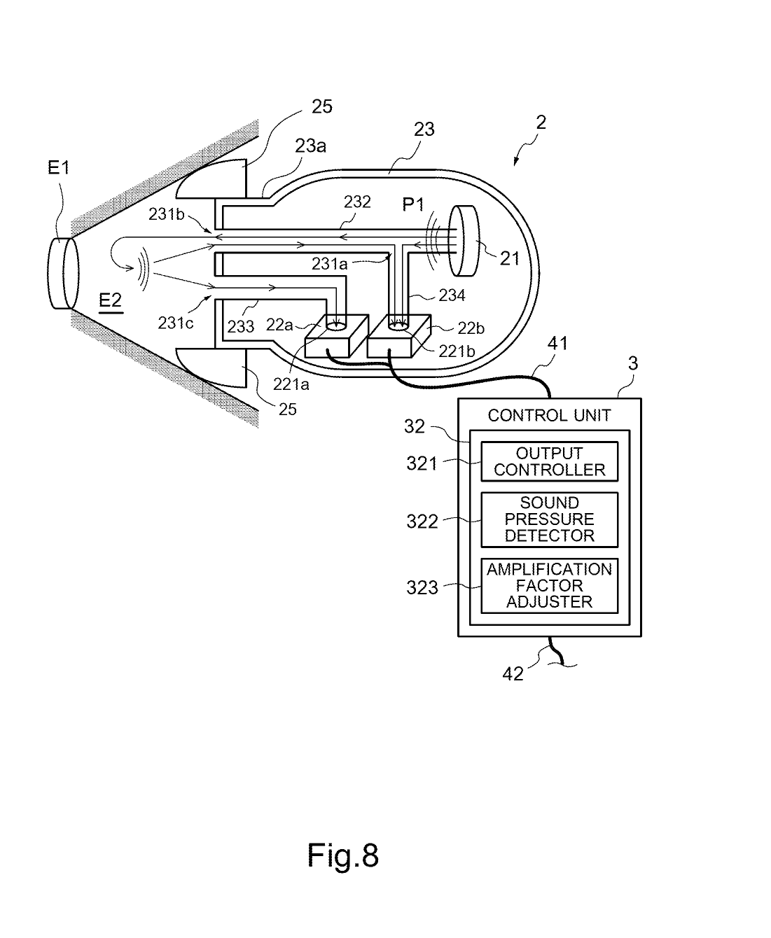

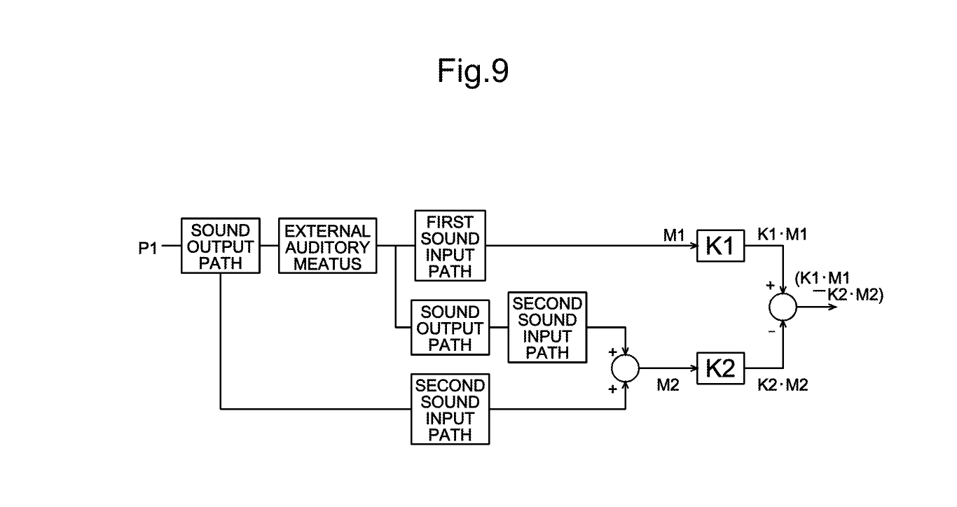

First, the case where the output sound from the speaker 21 is input to the first and second microphones 22a and 22b is described. FIG. 8 is a conceptual structural diagram illustrating a propagation path of the output sound from the speaker to be input to the first and second microphones in the first embodiment. In addition, FIG. 9 is a sound input block diagram of the output sound in the first embodiment. Note that in FIG. 8, the sound output direction of the speaker 21 is substantially parallel to the sound output path 232 for convenience sake.

As illustrated in FIG. 8, the output sound having sound pressure P1 output from the speaker 21 is output to the external auditory meatus E2 from the speaker 21 via the sound output path 232 and the second aperture 231b. The output sound output to the external auditory meatus E2 is echoed by the user's tympanum E1, the inner wall of the external auditory meatus E2, and the like. The echo component propagates to the first sound input path 233 and the sound output path 232.

The echo component propagating to the first sound input path 233 passes through the third aperture 231c and the first sound input path 233 so as to enter the first sound input hole 221a. The first microphone 22a generates the first sound signal having a first sound pressure level M1 corresponding to a first sound pressure of the echo component entering the first sound input hole 221a and outputs the first sound signal to the control device 32 as illustrated in FIG. 9.

On the other hand, the echo component propagating to the sound output path 232 passes through the second aperture 231b, the sound output path 232, the first aperture 231a, and the second sound input path 234 so as to enter the second sound input hole 221b. In addition, the output sound from the speaker 21 is directly input to the second sound input hole 221b from the sound output hole 21a of the speaker 21 via the sound output path 232, the first aperture 231a, and the second sound input path 234. In other words, sound including the output sound and the echo component is input to the second sound input hole 221b. The second microphone 22b generates a second sound signal having a second sound pressure level M2 corresponding to a second sound pressure of the sound input to the second sound input hole 221b, and outputs the second sound signal to the control device 32 as illustrated in FIG. 9.

The sound pressure detector 322 detects first and second sound pressure levels M1 and M2 of the first and second sound signals transmitted to the control device 32. The amplification factor adjuster 323 sets the gains K1 and K2 so that the first and second sound pressure levels M1 and M2 detected by the sound pressure detector 322 satisfy the following expression 1.

|K1*M1)−(K2*M2)|≈0 (expression 1)

K1≈(M2/M1)*K2

In other words, the amplification factor adjuster 323 sets the gains K1 and K2 so that an amplified first sound pressure level (K1*M1) of the amplified first sound signal and an amplified second sound pressure level (K2*M2) of the amplified second sound signal are substantially equal to each other. The output controller 321 uses the gains K1 and K2 set by the amplification factor adjuster 323 so as to amplify the first and second sound signals, and generates a difference sound signal between them.

In this way, a sound level of the difference sound signal based on the amplified first and second sound signals becomes substantially zero. In other words, the output sound from the speaker 21 and the echo component thereof input to the first and second microphones 22a and 22b can be substantially canceled by each other. Therefore, the earphone microphone 1 can cancel the echo component of output sound from the speaker 21.

((In Case Where Input Sound from Outside Sound Source is Input to First and Second Microphones))

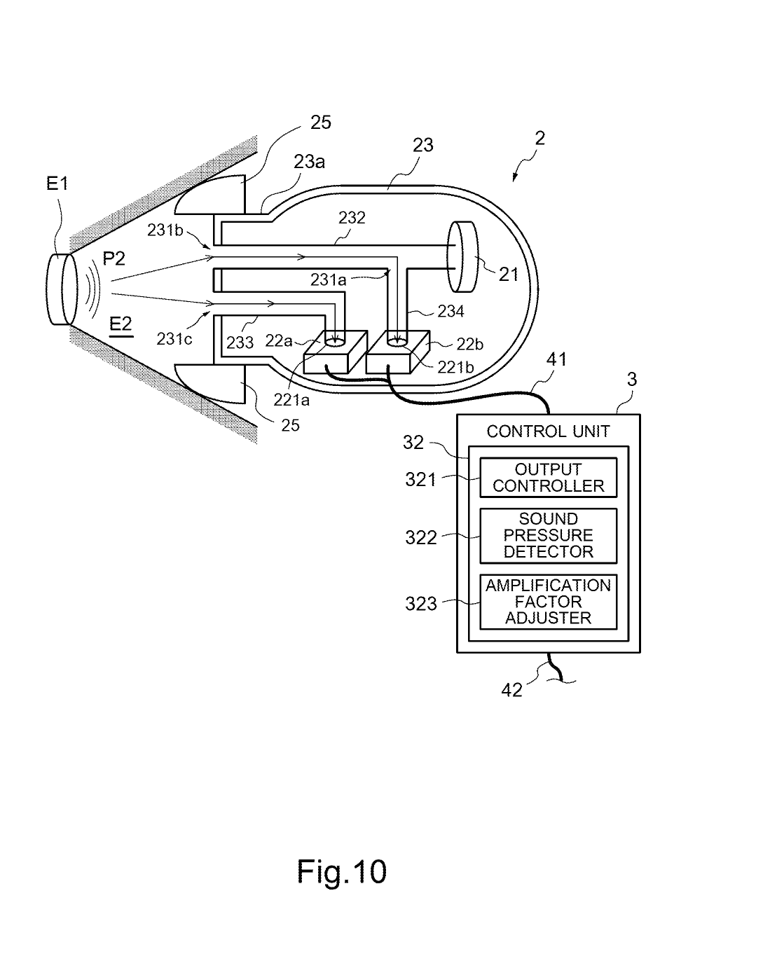

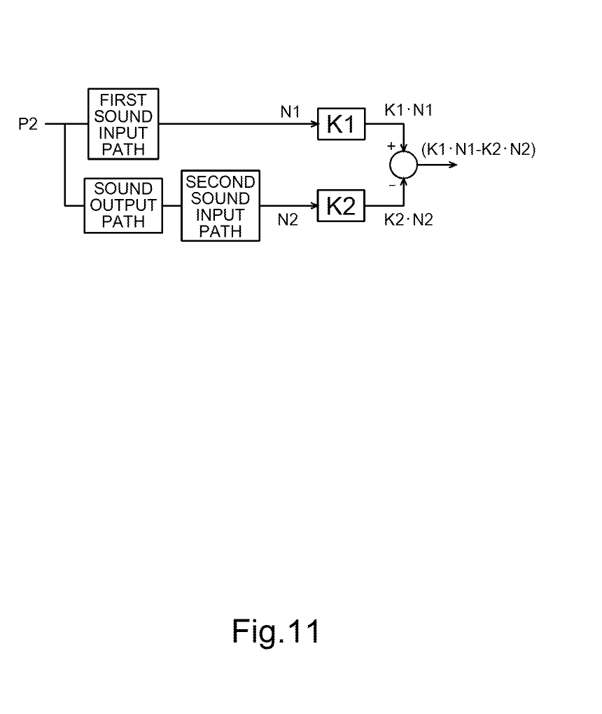

Next, the case where the input sound from the outside sound source (such as user's speaking voice) is input to the first and second microphones 22a and 22b is described. FIG. 10 is a conceptual structural diagram illustrating a propagation path of the input sound from the outside sound source to be input to the first and second microphones in the first embodiment. In addition, FIG. 11 is a sound input block diagram of the input sound in the first embodiment. Note that in FIG. 10, the sound output direction of the speaker 21 is substantially parallel to the sound output path 232 for convenience sake.

As illustrated in FIG. 10, when the earphone microphone 1 is inserted in the user's external auditory meatus E2 as illustrated in FIG. 2, the input sound having sound pressure P2 (such as user's speaking voice) propagates from the tympanum E1 and the external auditory meatus E2 to the first sound input path 233 and the sound output path 232. The input sound propagating in the first sound input path 233 passes through the third aperture 231c and the first sound input path 233 so as to enter the first sound input hole 221a. As illustrated in FIG. 11, the first microphone 22a generates the first sound signal having a third sound pressure level N1 corresponding to a third sound pressure of the input sound input to the first sound input hole 221 a so as to output the first sound signal to the control device 32.

On the other hand, the input sound propagating in the sound output path 232 passes through the second aperture 231b, the sound output path 232, the first aperture 231a, and the second sound input path 234 so as to enter the second sound input hole 221b. As illustrated in FIG. 11, the second microphone 22b generates the second sound signal having a fourth sound pressure level N2 corresponding to a fourth sound pressure of the input sound input to the second sound input hole 221b so as to output the second sound signal to the control device 32.

The sound pressure detector 322 detects third and fourth sound pressure levels N1 and N2 of the first and second sound signals to be transmitted to the control device 32. The amplification factor adjuster 323 sets the gains K1 and K2 so that the third and fourth sound pressure levels N1 and N2 detected by the sound pressure detector 322 satisfy the following expression 2.

|K1*N1−K2*N2|>0 (expression 2)

In other words, the amplification factor adjuster 323 sets the gains K1 and K2 so that a difference between an amplified third sound pressure level (K1 *N1) of the amplified first sound signal and an amplified fourth sound pressure level (K2*N2) of the amplified second sound signal becomes larger than zero. The output controller 321 uses the gains K1 and K2 set by the amplification factor adjuster 323 so as to amplify the first and second sound signals, and generates a difference sound signal between them.

In this way, the sound level of the difference sound signal based on the amplified first and second sound signals becomes larger than zero. Therefore, the input sounds are not canceled by each other, and hence the input sound from the outside sound source (such as user's speaking voice) to the first and second microphones 22a and 22b can be transmitted.

((Suppression of Echo Component))

In reality, the first and second microphones 22a and 22b simultaneously input the output sound from the speaker 21 and the input sound from the outside sound source (such as user's speaking voice). For this reason, the gains K1 and K2 are set so that the value of the expression 1 becomes smaller in a condition where the expression 2 is satisfied. In this way, the echo suppression function can be realized in the earphone microphone 1, and it is possible to transmit to the electronic equipment (not shown) the input sound in which the echo component of output sound from the speaker 21 is suppressed by the echo suppression function.

### Second Embodiment

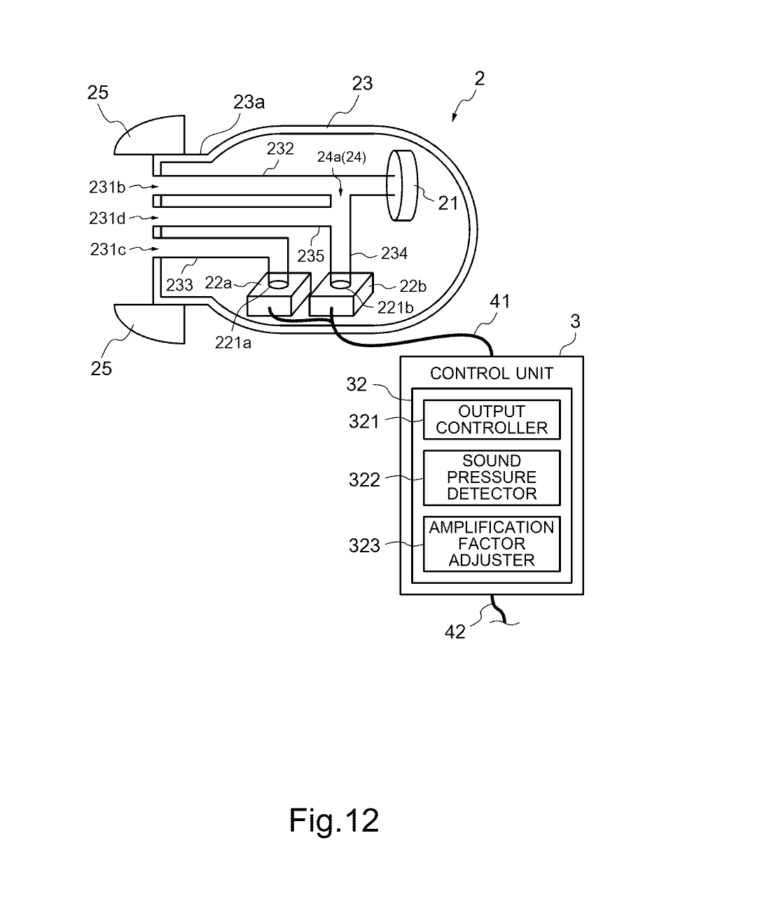

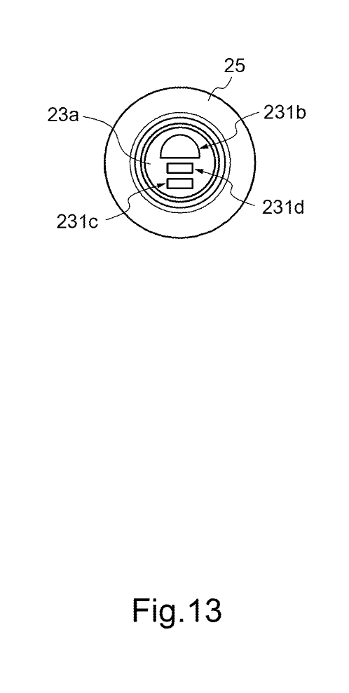

Next, the earphone microphone 1 of a second embodiment is described. FIG. 12 is a conceptual structural diagram of the earphone microphone according to the second embodiment. In addition, FIG. 13 is a front view of a main body viewed from the user's external auditory meatus in the second embodiment.

As illustrated in FIGS. 12 and 13, in the second embodiment, a fourth aperture 231d is further formed in the insertion part 23a on the surface on which the second and third apertures 231b and 231c are formed. In addition, the acoustic space inside the main body casing 23 further includes a third sound input path 235 that communicates outside of the main body casing 23 with the second sound input path 234 via the fourth aperture 231d. Other structures are the same as in the first embodiment. In the following description, the same structure as in the first embodiment is denoted by the same numeral, and description thereof is omitted.

(Structure of Earphone Microphone)

As illustrated in FIG. 12, in the second embodiment, there is formed the acoustic space including the sound output path 232, the first sound input path 233, the second sound input path 234, and the third sound input path 235 inside the main body casing 23. The third sound input path 235 is a sound path communicating the fourth aperture 231d with the second sound input path 234. The sound such as the echo component of output sound from the speaker 21 and the input sound from the outside sound source propagates in the third sound input path 235 from the outside of the main body casing 23. The third sound input path 235 conducts the sound to the second sound input path 234.

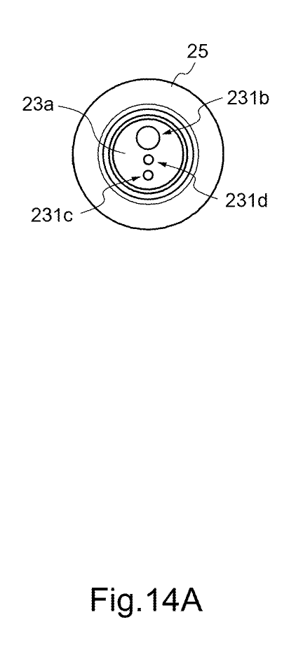

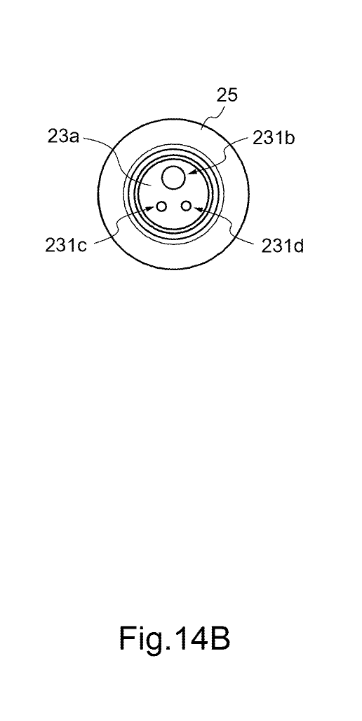

In addition, as illustrated in FIG. 13, in the second embodiment, three apertures (second to fourth apertures 231b, 231c, and 231d) are formed in the insertion part 23a on the surface that is opposed to the user's tympanum E1 when the main body 2 is set to the user's ear EAR. Note that the shapes of the apertures 231b, 231c, and 231d formed in the insertion part 23a are not limited to specific shapes. FIGS. 14A and 14B are front views illustrating other examples of forming the second to fourth apertures in the second embodiment. For instance, the shapes of the second to fourth apertures 231b, 231c, and 231d may be a circler shape (see FIG. 14A) or a polygonal shape such as a rectangle or a triangle.

In addition, the shapes as well as sizes of the second to fourth apertures 231b, 231c, and 231d may be substantially the same or may be different from each other. In addition, the second to fourth apertures 231b, 231c, and 231d may be arranged in a predetermined direction as illustrated in FIGS. 13 and 14A. Alternatively, they may be arranged so that centers of the apertures 231b, 231c, and 231d are positioned at apexes of an imaginary triangle as illustrated in FIG. 14B.

(Echo Suppression Function of Earphone Microphone)

Next, the echo suppression function of the earphone microphone 1 according to the second embodiment is described in the case where the output sound from the speaker 21 is input to the first and second microphones 22a and 22b, and in the case where the input sound from the outside sound source (such as user's speaking voice) is input to the first and second microphones 22a and 22b.

((In Case Where Output Sound From Speaker is Input to First and Second Microphones))

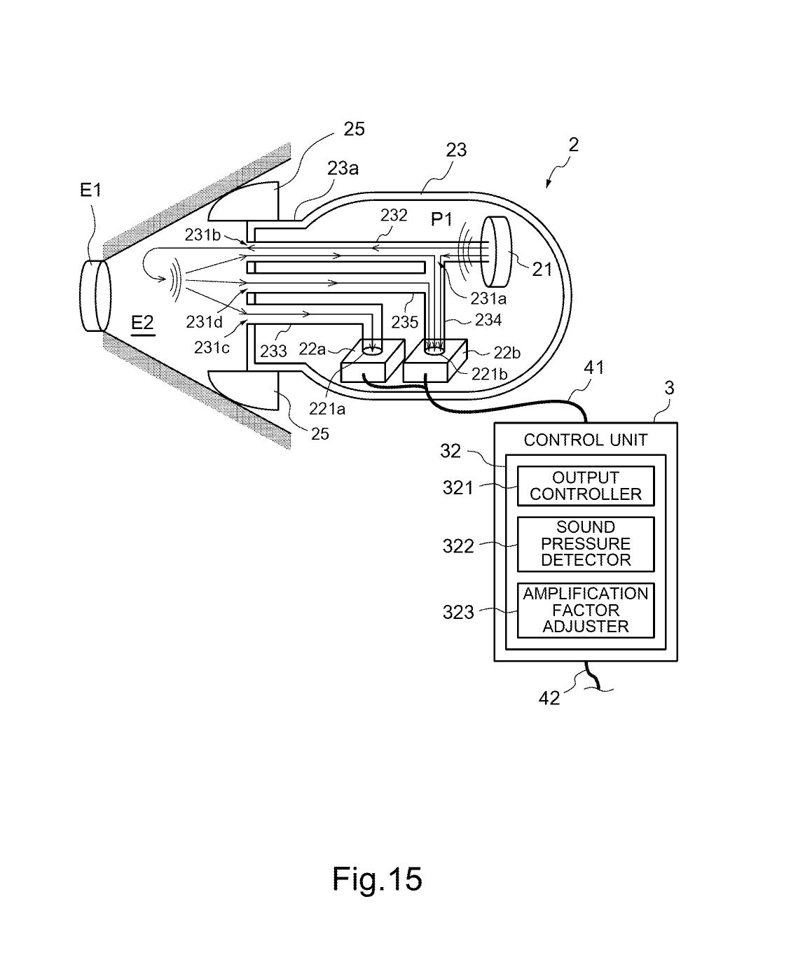

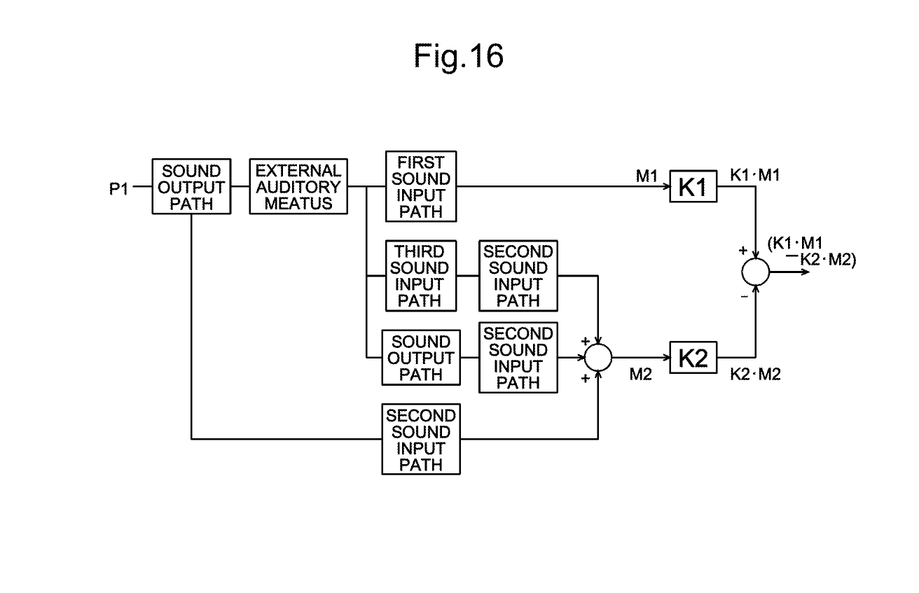

First, the case where the output sound from the speaker 21 is input to the first and second microphones 22a and 22b is described. FIG. 15 is a conceptual structural diagram illustrating a propagation path of the output sound from the speaker to be input to the first and second microphones in the second embodiment. In addition, FIG. 16 is a sound input block diagram of the output sound in the second embodiment. Note that in FIG. 15, the sound output direction of the speaker 21 is substantially parallel to the sound output path 232 for convenience sake.

As illustrated in FIG. 15, the output sound having sound pressure P1 output from the speaker 21 is output to the external auditory meatus E2 from the speaker 21 via the sound output path 232 and the second aperture 231b. The output sound output to the external auditory meatus E2 is echoed by the user's tympanum E1, the inner wall of the external auditory meatus E2, and the like. The echo component propagates to the first sound input path 233, the third sound input path 235, and the sound output path 232.

The echo component propagating to the first sound input path 233 passes through the third aperture 231c and the first sound input path 233 so as to enter the first sound input hole 221a. The first microphone 22a generates the first sound signal having the first sound pressure level M1 corresponding to a first sound pressure of the echo component entering the first sound input hole 221a and outputs the first sound signal to the control device 32 as illustrated in FIG. 16.

On the other hand, the echo component propagating to the third sound input path 235 passes through the fourth aperture 231d, the third sound input path 235, and the second sound input path 234 so as to enter the second sound input hole 221b. In addition, the echo component propagating in the sound output path 232 passes through the second aperture 231b, the sound output path 232, the first aperture 231a, and the second sound input path 234 so as to enter the second sound input hole 221b. Further, the output sound from the speaker 21 is directly input to the second sound input hole 221b from the sound output hole 21a of the speaker 21 via the sound output path 232, the first aperture 231a, and the second sound input path 234. For this reason, sound including the output sound and the echo component propagating via the two sound paths is input to the second sound input hole 221b. The second microphone 22b generates the second sound signal having the second sound pressure level M2corresponding to the second sound pressure of the sound input to the second sound input hole 221b, and outputs the second sound signal to the control device 32 as illustrated in FIG. 16.

The sound pressure detector 322 detects the first and second sound pressure levels M1 and M2 of the first and second sound signals to be transmitted. The amplification factor adjuster 323 sets the gains K1 and K2 so that the first and second sound pressure levels M1 and M2 detected by the sound pressure detector 322 satisfy the following expression 3.

|(K1*M1)−(K2*M2)|≈0 (expression 3)

K1¢(M2/M1)*K2

In other words, the amplification factor adjuster 323 sets the gains K1 and K2 so that an amplified first sound pressure level (K1*M1) of the amplified first sound signal and an amplified second sound pressure level (K2*M2) of the amplified second sound signal are substantially equal to each other. The output controller 321 uses the gains K1 and K2 set by the amplification factor adjuster 323 so as to amplify the first and second sound signals, and generates a difference sound signal between them.

In this way, the sound level of the difference sound signal based on the amplified first and second sound signals becomes substantially zero. In other words, the echo component of output sound from the speaker 21 input to the first and second microphones 22a and 22b can be substantially canceled. Therefore, the earphone microphone 1 can cancel the echo component of output sound from the speaker 21.

((In Case Where Input Sound from Outside Sound Source is Input to First and Second Microphones))

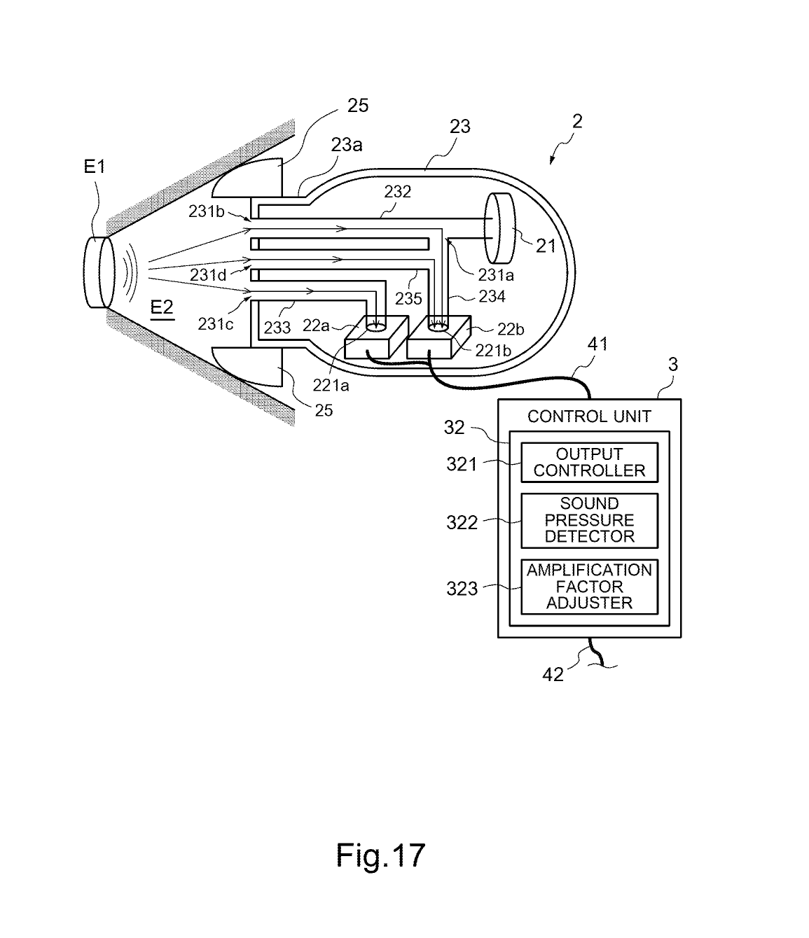

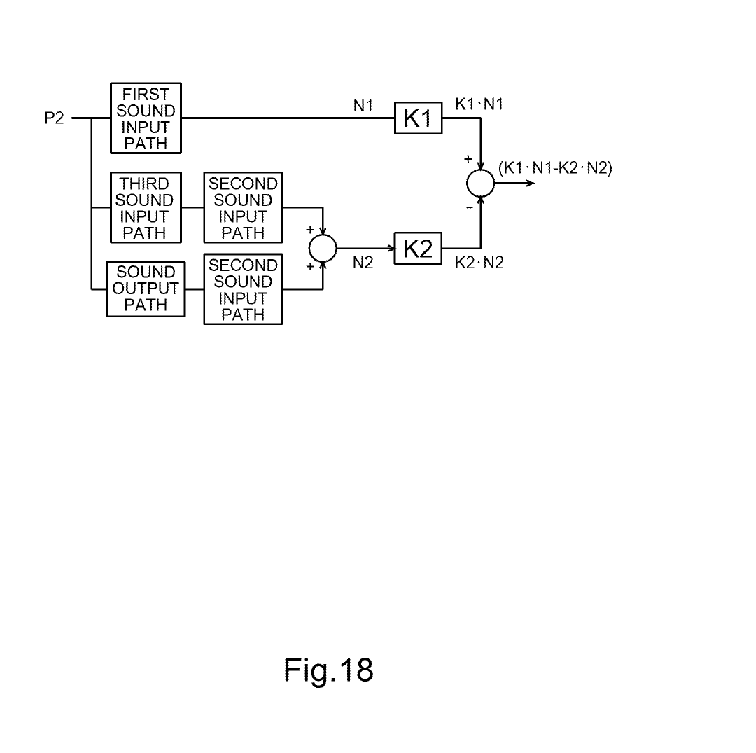

Next, the case where the input sound from the outside sound source (such as user's speaking voice) is input to the first and second microphones 22a and 22b is described. FIG. 17 is a conceptual structural diagram illustrating a propagation path of the input sound from the outside sound source to be input to the first and second microphones in the second embodiment. In addition, FIG. 18 is a sound input block diagram of the input sound in the second embodiment. Note that in FIG. 17, the sound output direction of the speaker 21 is substantially parallel to the sound output path 232 for convenience sake.

As illustrated in FIG. 17, when the earphone microphone 1 is inserted in the user's external auditory meatus E2 as illustrated in FIG. 2, input sound having the sound pressure P2 (such as user's speaking voice) propagates from the tympanum E1 and the external auditory meatus E2 to the first sound input path 233, the third sound input path 235, and the sound output path 232. The input sound propagating in the first sound input path 233 passes through the third aperture 231c and the first sound input path 233 so as to enter the first sound input hole 221a. As illustrated in FIG. 18, the first microphone 22a generates the first sound signal having the third sound pressure level N1 corresponding to the third sound pressure of the input sound input to the first sound input hole 221a so as to output the first sound signal to the control device 32.

In addition, the input sound propagating in the third sound input path 235 passes through the fourth aperture 231d, the third sound input path 235, and the second sound input path 234 so as to enter the second sound input hole 221b. In addition, the input sound propagating in the sound output path 232 passes through the second aperture 231b, the sound output path 232, the first aperture 231a, and the second sound input path 234 so as to enter the second sound input hole 221b. In other words, sound including the input sounds from two sound paths is input to the second sound input hole 221b. As illustrated in FIG. 18, the second microphone 22b generates the second sound signal having the fourth sound pressure level N2 corresponding to the fourth sound pressure of the input sound input to the second sound input hole 221b, and outputs the second sound signal to the control device 32.

The sound pressure detector 322 detects the third and fourth sound pressure levels N1 and N2 of the first and second sound signals to be transmitted. The amplification factor adjuster 323 sets the gains K1 and K2 so that the third and fourth sound pressure levels N1 and N2 detected by the sound pressure detector 322 satisfy the following expression 4.

|(K1*N1)−(K2*N2)|>0 (expression 4)

In other words, the amplification factor adjuster 323 sets the gains K1 and K2 so that a difference between the amplified third sound pressure level (K1*N1) of the amplified first sound signal and the amplified fourth sound pressure level (K2*N2) of the amplified second sound signal becomes larger than zero. The output controller 321 uses the gains K1 and K2 set by the amplification factor adjuster 323 so as to amplify the first and second sound signals, and generates a difference sound signal between them.

In this way, the sound level of the difference sound signal based on the amplified first and second sound signals becomes larger than zero. For this reason, the input sounds are not canceled by each other, and hence the input sound from the outside sound source (such as user's speaking voice) input to the first and second microphones 22a and 22b can be transmitted.

((Suppression of Echo Component))

In reality, the first and second microphones 22a and 22b simultaneously input the output sound from the speaker 21 and the input sound from the outside sound source (such as user's speaking voice). For this reason, the gains K1 and K2 are set so that the value of the expression 3 becomes smaller in a condition where the expression 4 is satisfied. In this way, the echo suppression function can be realized in the earphone microphone 1, and it is possible to transmit to the electronic equipment (not shown) the input sound in which the echo component of the output sound from the speaker 21 is suppressed by the echo suppression function.

The embodiments of the present invention are described above. Note that the embodiments described above are merely examples, and combinations of the components and the processes can be modified variously, which are understood to be in the scope of the present invention by a skilled person in the art.

For instance, in the first and second embodiments described above, the amplification factor adjuster 323 automatically sets the gains K1 and K2 on the basis of a result of the detection by the sound pressure detector 322, but the application range of the present invention is not limited to this structure. The amplification factor adjuster 323 may automatically set only one of the gains K1 and K2 on the basis of a result of the detection by the sound pressure detector 322. In this way, the earphone microphone 1 can realize the echo suppression function with more simple structure.

In addition, in the first and second embodiments described above, when the output sound from the speaker 21 is input to the first and second microphones 22a and 22b, the gains K1 and K2 are set to a condition where the difference |K1*M1−K2*M2| between the amplified first and second sound pressure levels of the amplified first and second sound signals becomes substantially zero. However, the application range of the present invention is not limited to this structure. It is sufficient that the gains K1 and K2 is set to a condition where the difference |K1*M1−K2*M2| between the first and second sound pressure levels becomes smaller after the amplification than before the amplification of the first and second sound signals. In this way, the earphone microphone 1 can realize the echo suppression function.

In addition, in the first and second embodiments described above, when the input sound from the outside sound source is input to the first and second microphones 22a and 22b, the gains K1 and K2 are set to the condition (see expressions 2 and 4) where the difference between the amplified third and fourth sound pressure levels of the amplified first and second sound signals becomes larger than zero. Here, the input sound transmitted from the earphone microphone 1 becomes largest in the condition where a difference |K1*N1−K2*N2| between the amplified third and fourth sound pressure levels becomes largest. Therefore, it is desired that the gains K1 and K2 are set to the condition where the difference |K1*N1−K2*N2| becomes largest. In this way, the sound pressure level of the input sound from which noise due to the echo component of the output sound from the speaker 21 is removed can be maximized. Therefore, the input sound from the outside sound source to the earphone microphone 1 can be transmitted with the highest sound pressure level.

In addition, in the first and second embodiments described above, when the first and second microphones 22a and 22b input the output sound and the input sound simultaneously, the gains K1 and K2 are set so that the value of the expression 1 (or the expression 3) becomes smaller in the condition where the expression 2 (or the expression 4) is satisfied. In this case, it is desired that the gains K1 and K2 are set to satisfy the expression 1 and the expression 2 (or the expression 3 and the expression 4). In this way, the echo suppression function of the earphone microphone 1 can be used to the full so as to transmits to the electronic equipment (not shown) the input sound from which the echo component of the output sound from the speaker 21 is substantially removed.

Further, in this case, it is desired that the gains K1 and K2 are set to a condition where the value of the expression 2 (or the expression 4) becomes largest (namely, a condition where the difference |K1*N1−K2*N2| between the amplified third and fourth sound pressure levels becomes largest) in the condition where the expression 1 (or the expression 3) is satisfied. In this way, the earphone microphone 1 can transmit to the electronic equipment (not shown) the input sound from which the echo component of the output sound from the speaker 21 is substantially removed.

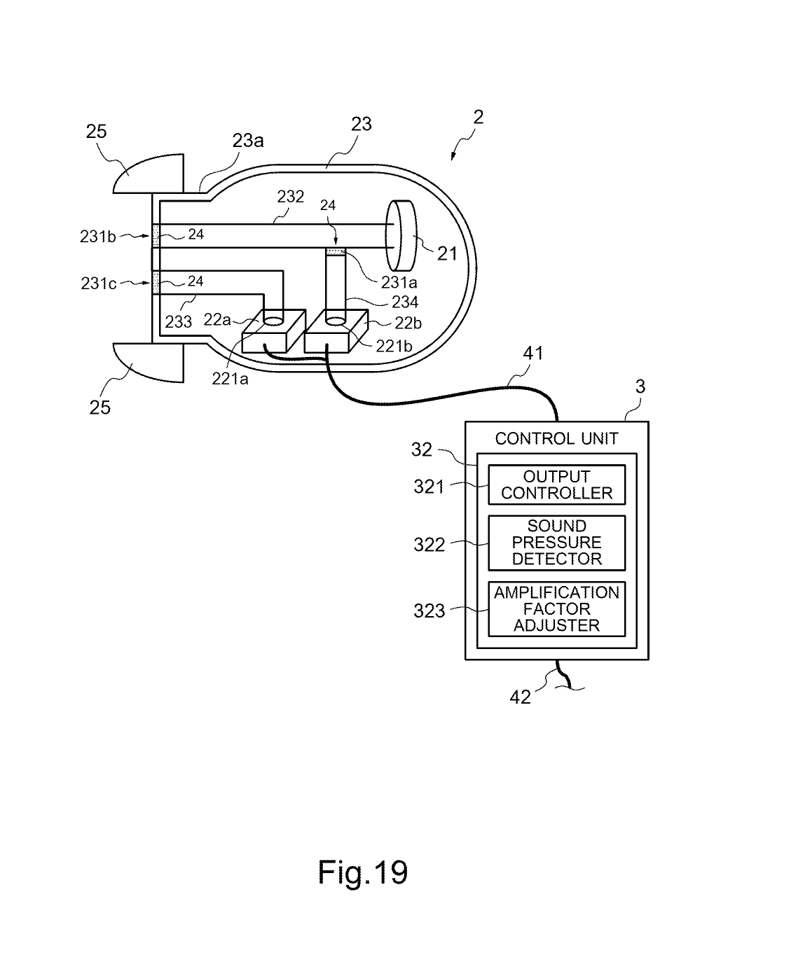

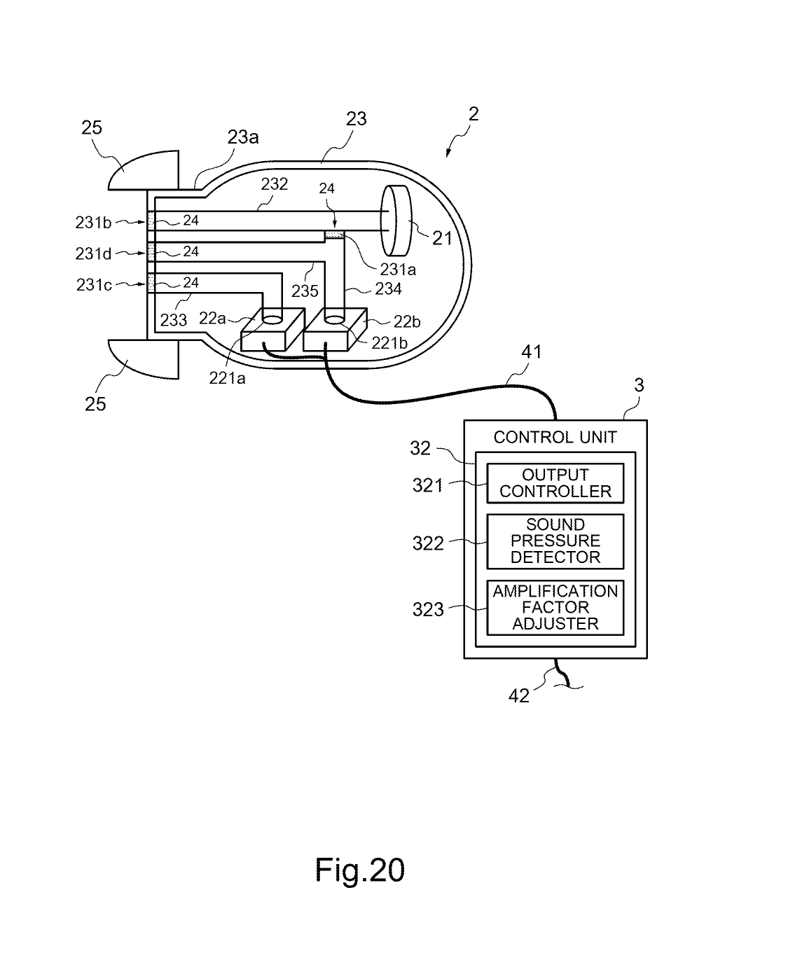

In addition, in the first and second embodiments described above, a member for blocking or attenuating the propagating sound is not disposed in the sound output path 232, the first to third sound input paths 233 to 235, and the first to fourth apertures 231a to 231d, but the present invention is not limited to these structures. FIG. 19 is a conceptual structural diagram illustrating another example of the earphone microphone according to the first embodiment. In addition, FIG. 20 is a conceptual structural diagram illustrating another example of the earphone microphone according to the second embodiment. As illustrated in FIGS. 19 and 20, an acoustic resistor 24 for blocking or attenuating the propagating sound may be disposed in the sound output path 232, the first to third sound input paths 233 to 235, and the first to fourth apertures 231a to 231d. Note that without limiting to the examples of FIG. 19 and FIG. 20, the acoustic resistor 24 may be disposed in at least one of the sound output path 232, the first to third sound input paths 233 to 235, and the first to fourth apertures 231a to 231d. In this way, in addition to setting of the gains K1 and K2, acoustic resistance of the acoustic resistor 24 also enables the input sound from the outside sound source to be input while suppressing input of the echo component. Therefore, flexibility in designing the earphone microphone 1 can be enhanced so that the echo suppression function can be realized more easily.

In addition, in the first and second embodiments described above, the earphone microphone 1 includes the single main body 2 as illustrated in FIG. 1, but the present invention is not limited to this structure. The earphone microphone 1 may include two main bodies 2. Further, one of the two main bodies 2 may not have the echo suppression function. In other words, it is possible that the one of the two main bodies 2 includes the speaker 21 but does not include the first and second microphones 22a and 22b. In this way, the user can hear the output sound from the earphone microphone 1 by both ears.

In addition, in the first and second embodiments described above, in order to facilitate understanding of the structure for realizing the echo suppression function of the earphone microphone 1, the conceptual structural diagram and the sound input block diagram of the earphone microphone 1 are illustrated separately in FIGS. 8 to 11 and in FIGS. 12 and 15 to 18. The structure illustrated in FIGS. 12 and 15 to 18 can be considered to be substantially the same as that illustrated in FIGS. 8 to 11 if the sound does not propagate in the third sound input path 235.

In the embodiment described above, the earphone microphone 1 includes the single speaker 21, the first and second microphones 22a and 22b, the main body casing 23 in which the acoustic space is formed, and the output controller 321. In addition, the output controller 321 amplifies the sound signal output from at least one of the first and second microphones 22a and 22b. The acoustic space contains the sound output path 232, the first sound input path 233, and the second sound input path 234. The output sound from the speaker 21 propagates in the sound output path 232. The first sound input path 233 communicates with the outside of the main body casing 23. In addition, the sound to be input to the first microphone 22a propagates in the first sound input path 233. The sound to be input to the second microphone 22b propagates in the second sound input path 234. In addition, the sound output path 232 branches into the one path communicating with the outside of the main body casing 23 and the other path communicating with the second sound input path 234. The earphone microphone 1 amplifies the sound signal so as to input the sound from the sound source (such as user's speaking voice) outside the main body casing 23, and suppresses input of the output sound from the speaker 21.

With this structure, the earphone microphone 1 includes the single speaker 21. In addition, the sound output path 232 branches into the one path communicating with the outside of the main body casing 23 and the other path communicating with the second sound input path 234. For this reason, the output sound from the speaker 21 propagates to the first microphone 22a via the one path and the first sound input path 233, and also propagates to the second microphone 22b via the other path and the second sound input path 234. Further, the earphone microphone 1 amplifies the sound signal output from at least one of the first and second microphones 22a and 22b so as to input the sound from the outside sound source, and suppresses the input of the output sound from the speaker 21. For this reason, the earphone microphone 1 can realize the echo suppression function of the output sound from the speaker 21 without using a plurality of speakers. Further, the earphone microphone 1 can transmit the input sound while suppressing noise due to the output sound from the speaker 21. Therefore, it is possible to provide the earphone microphone 1 having the echo suppression function, which is inexpensive and can be downsized.

In addition, in the embodiments described above, the earphone microphone 1 further includes the sound pressure detector 322 for detecting the sound pressure levels of the sound signals, and the amplification factor adjuster 323 for setting the gains (amplification factors) K1 and K2 of the sound signals on the basis of a result of the detection by the sound pressure detector 322. In addition, the gains K1 and K2 of the sound signals are set so that the difference between the first sound pressure level M1 of the first sound signal based on the output sound from the speaker 21 input to the first microphone 22a and the second sound pressure level M2 of the second sound signal based on the output sound input to the second microphone 22b becomes smaller after the amplification than before the amplification of the sound signal. Further, the gains K1 and K2 are set so that one of the third sound pressure level N1 of the first sound signal based on the input sound from the outside sound source to the first microphone 22a and the fourth sound pressure level N2 of the second sound signal based on the input sound input to the second microphone 22b becomes larger than the other.

With this structure, the amplification factor adjuster 323 sets the gains K1 and K2 of the sound signals on the basis of a result of the detection by the sound pressure detector 322. In addition, by setting the gains K1 and K2, the output sounds from the speaker 21 to be input to the first and second microphones 22a and 22b can be weakened by each other. On the other hand, it is possible to configure that the input sounds input from the outside sound source (such as user's speaking voice) to the first and second microphones 22a and 22b are not canceled by each other. Therefore, it is possible to transmit the input sound while suppressing noise due to the output sound from the speaker 21.

Further, it is desired that the gains K1 and K2 of the sound signals are set so that the first sound pressure level M1 is substantially equal to the second sound pressure level M2 and that one of the third and fourth sound pressure levels N1 and N2is larger than the other.

In this way, by setting the gains K1 and K2 of the sound signals, the output sounds from the speaker 21 to be input to the first and second microphones 22a and 22b can be canceled by each other. On the other hand, it is possible to configure that the input sounds input to the first and second microphones 22a and 22b from the outside sound source (such as user's speaking voice) are not canceled by each other. Therefore, it is possible to transmit the input sound without mixing the output sound from the speaker 21 as noise.

Further, it is desired that the gains K1 and K2 of the sound signals are set so that the first sound pressure level M1 becomes substantially equal to the second sound pressure level M2, and that a difference between the third and fourth sound pressure levels N1 and N2 becomes largest.

In this way, by setting the gains K1 and K2 of the sound signals, it is possible that the output sounds from the speaker 21 to be input to the first and second microphones 22a and 22b are canceled by each other. On the other hand, the input sound input to the first and second microphones 22a and 22b from the outside sound source (such as user's speaking voice) can have a largest level. Therefore, it is possible to transmit the input sound without mixing the output sound from the speaker 21 as noise.

In addition, in the embodiments described above, it is desired that the first sound signal output from the first microphone 22a is amplified more largely than the second sound signal output from the second microphone 22b.

With this structure, the first sound signal is amplified more largely than the second sound signal. The output sound from the speaker 21 is input through more paths to the second microphone 22b than to the first microphone 22a. For this reason, the first sound pressure level M1 of the first sound signal is usually lower than the second sound pressure level M2 of the second sound signal. Therefore, by amplifying the first sound signal more largely than the second sound signal, the echo suppression function can be realized without setting the gain K1 or K2 of at least one of the first and second sound signals so large.

What is claimed is:

1. An earphone microphone comprising:
a single speaker;
a first microphone;
a second microphone;
a main body casing in which an acoustic space is formed; and
an output controller which amplifies a sound signal output from at least one of the first microphone and the second microphone, wherein
the acoustic space includes a sound output path in which output sound from the speaker propagates, a first sound input path communicating with outside of the main body casing, in which sound to be input to the first microphone propagates, and a second sound input path in which sound to be input to the second microphone propagates,
the sound output path branches into one path communicating with the outside of the main body casing and the other path communicating with the second sound input path, and
the sound signal is amplified so that input sound from a sound source outside the main body casing is input while input of the output sound from the speaker is suppressed.

2. The earphone microphone according to claim 1, further comprising:
a sound pressure detector for detecting a sound pressure level of the sound signal; and
an amplification factor adjuster for setting an amplification factor of the sound signal on the basis of a result of the detection by the sound pressure detector, wherein
the amplification factor of the sound signal is set so that
a difference between a first sound pressure level of a first sound signal based on the output sound from the speaker to be input to the first microphone and a second sound pressure level of a second sound signal based on the output sound to be input to the second microphone is smaller after amplification of the sound signal than before the amplification, and that
one of a third sound pressure level of the first sound signal based on the input sound from the outside sound source to be input to the first microphone and a fourth sound pressure level of the second sound signal based on the input sound to be input to the second microphone is larger than the other.

3. The earphone microphone according to claim 2, wherein the amplification factor of the sound signal is set so that the first sound pressure level is substantially equal to the second sound pressure level, and that one of the third sound pressure level and the fourth sound pressure level is larger than the other.

4. The earphone microphone according to claim 3, wherein the amplification factor of the sound signal is set so that the first sound pressure level is substantially equal to the second sound pressure level, and that a difference between the third sound pressure level and the fourth sound pressure level becomes largest.

5. The earphone microphone according to claim 1, wherein the first sound signal output from the first microphone is amplified more largely than the second sound signal output from the second microphone.
